(19) United States
(12) Patent Application Publication
(10) Pub. No.: US 2010/0010169 A1
(43) Pub. Date: Jan. 14, 2010

(54) SHAPE MEMORY MATERIALS AND METHOD FOR FABRICATING THE SAME

(75) Inventors: YU-HSIN TSAI, Hsinchu (TW); CHIEN-PANG WU, Changhua County (TW)

Correspondence Address: PAI PATENT & TRADEMARK LAW FIRM, 1001 FOURTH AVENUE, SUITE 3200, SEATTLE, WA, 98154, US

(73) Assignee: INDUSTRIAL TECHNOLOGY RESEARCH INSTITUTE, Hsinchu County (TW)

(21) Appl. No.: 12/332,349

(22) Filed: Dec. 11, 2008

(30) Foreign Application Priority Data
Jul. 8, 2008 (TW) 097125676

(51) Int. Cl. C08L 67/00

(52) U.S. Cl. 525/419

(57) ABSTRACT

Materials having shape memory properties and method for fabricating the same are provided. The material having shape memory properties includes a blend prepared by melt blending an amorphous polyester and a semi-crystalline polyester. The method for fabricating shape memory material includes melt blending an amorphous polyester and a semi-crystalline polyester.

### CROSS REFERENCE TO RELATED APPILCATIONS

This application is based upon and claims the benefit of priority from the prior Taiwan Patent Application No. 97125676, filed on Jul. 8, 2008, the entire contents of which are incorporated herein by reference.

### BACKGROUND OF THE INVENTION

1. Field of the Invention

The invention relates to shape memory materials and method for fabricating the same, and more particularly, to shape memory materials with high shape recovery rate and method for fabricating the same.

2. Description of the Related Art

Shape memory materials have been the subject of much expectation and have been widely and aggressively developed due to their outstanding properties. Shape memory materials feature an ability to transform from a temporary, frozen, shape to a permanent shape when triggered by an environmental stimulus, such as heat, light, or vapor.

In the related industry, shape memory materials have been successfully used in connection with a wide variety of applications including medical devices, dentistry, mechanics and other applications.

More particularly, shape memory polymers can be deformed to a desired shape when heated beyond the glass transition temperature, and when the temperature is decreased below the glass transition temperature, the deformed shape is rigidly fixed while at the lower temperature. At the same time, the mechanical energy expended on the material during deformation is stored. Thereafter, when the temperature is raised above the glass transition temperature again, the polymer will recover to its original form.

The conventional shape memory materials are metal alloys with shape memory properties, such as TiNi, CuZnAl, and FeNiAl. The shape memory alloys, however, were not widely used due to their high reverse transformation temperatures and costs.

Shape memory polymers, with lighter weights, higher shape recoverable properties, higher potential for shaping, and lower costs, have been developed to replace shape memory alloys.

Recently, most commercial shape memory products are made of shape memory polymers which are prepared via chemical synthesis. U.S. Pat. No. 6,858,680 B2 disclosed a polyurethane shape memory material comprising siloxane. The aforementioned shape memory material, however, has low practicability and applicability due to the high cost of raw material and complicated synthesis. Further, U.S. Pat. No. 7,091,297B2 discloses a shape memory material including a product formed by ring-opening polymerizing cyclooctene with dicumyl peroxide (as a cross-linking agent). However, the synthesis and purification processes thereof are complicated.

U.S. Pat. No. 7,208,550 B2 disclose a method for fabricating shape memory materials via physical blending rather than chemical synthesis. The method includes melt blending the polymers (such as polyvinyl acetate, polymethyl acrylate, polyethyl acrylate, atactic poly methyl methacrylate, isotatic poly methyl methacrylate, syndiotactic poly methyl methacrylate, polyvinylidene fluoride, poly lactide, polyhydroxybutyrate, polyethylene glycol, poly ethylene, polyvinyl chloride, or polyvinylidene chloride), thereby obtaining shape memory materials. In comparison with conventional chemical synthesis, the process for fabricating shape memory materials via physical blending is more convenient.

However, the raw polymers used in physical blending of U.S. Pat. No. 7,208,550 B2 are expensive and not fulfill the demands of environmental friendly since partial raw polymers contain chlorine and fluorine atoms. Further, there are difficulties surrounding the shape recovery ability of shape memory materials disclosed in U.S. Pat. No. 7,208,550 B2.

Therefore, it is necessary to develop a novel shape memory material, prepared from cheaper and more accessible raw polymers, having high shape recovery ability and workability.

### BRIEF SUMMARY OF THE INVENTION

An exemplary embodiment of a shape memory material includes a blend prepared by melt blending an amorphous polyester and a semi-crystalline polyester, wherein the weight ratio between the amorphous polyester and the semi-crystalline polyester is between 9:1 and 1:9.

It should be noted that the glass transition temperature of the shape memory material is modified by the weight ratio between the amorphous polyester and the semi-crystalline polyester. Further, the shape recovery rate of the shape memory material is modified by the weight ratio between the amorphous polyester and the semi-crystalline polyester. Moreover, the start-up of shape memory ability of the shape memory material is achieved by heating the shape memory material over the glass transition temperature thereof.

In embodiments of the invention, the amorphous polyester can exhibit a physical property of non-crystallization and can include poly(ethylene-co-cyclohexane dimethanol terephthalate) (PETG). The semi-crystalline polyester can exhibit a physical property of crystallization and can include poly(ethylene terephthalate) (PET) represented by following structure:

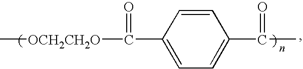

wherein n is an integer of more than 1.

The semi-crystalline polyester can include poly(ethylene terephthalate-co-ethylene succinate) (PETS) represented by following structure:

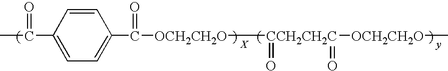

wherein x and y are an integer of more than 1 and the ratio of x and y is between 20:1 and 1:20, such as 17:3.

The semi-crystalline polyester can include poly(butylene terephthalate) (PBT) represented by following structure:

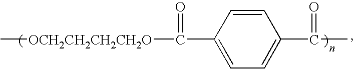

wherein n is an integer of more than 1.

Another exemplary embodiment a method for fabricating a shape memory material includes melt blending an amorphous polyester and a semi-crystalline polyester.

The shape memory materials spontaneously feature a shape memory behavior when ambient temperature exceeds the glass transition temperature thereof.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a graph plotting the glass transition temperature against PETS weight ratio of shape memory materials disclosed in Examples 1-5.

FIG. 2 is a graph plotting shape recovery rate of shape memory materials disclosed in Examples 1-5 against test times.

### DETAILED DESCRIPTION OF THE INVENTION

The following description is of the embodiments of carrying out the invention. This description is made for the purpose of illustrating the general principles of the invention and should not be taken in a limiting sense. The scope of the invention is best determined by reference to the appended claims.

Preparation of Shape Memory Materials

### EXAMPLES 1-5

First, PETG (as amorphous polyester) and PETS (as semi-crystalline polyester) were mixed according to different ratios disclosed in Table. 1 and dried by a vacuum oven at 80° C. for 12 hrs. Next, the mixture was subjected to a melt blending process by a twin screw extruder with a melting temperature of 210-260° C. and a screw speed of 300-500 r.p.m.

TABLE 1

| | | Exam- | Exam- | Exam- | | |
|---|---|---|---|---|---|---|
| | | ple 1 | ple 2 | ple 3 | Example 4 | Example 5 |
| percentage | PETG | 100 | 75 | 50 | 25 | 0 |
| (%) | PETS | 0 | 25 | 50 | 75 | 100 |
| weight | PETG | 2 | 1.5 | 1.0 | 0.5 | 0 |
| (Kg) | PETS | 0 | 0.5 | 1.0 | 1.5 | 2 |

### EXAMPLES 6-10

First, PETG (as amorphous polyester) and PET (as semi-crystalline polyester) were mixed according to different ratios disclosed in Table. 2 and dried by a vacuum oven at 80° C. for 12 hrs. Next, the mixture was subjected to a melt blending process by a twin screw extruder with a melting temperature of 210-260° C. and a screw speed of 300-500 r.p.m.

TABLE 2

| | | | Exam- | Exam- | Exam- | Example |
|---|---|---|---|---|---|---|
| | | Example 6 | ple 7 | ple 8 | ple 9 | 10 |
| percentage | PETG | 100 | 75 | 50 | 25 | 0 |
| (%) | PET | 0 | 25 | 50 | 75 | 100 |
| weight | PETG | 2 | 1.5 | 1.0 | 0.5 | 0 |
| (Kg) | PET | 0 | 0.5 | 1.0 | 1.5 | 2 |

Measurement of Glass Transition Temperature

### EXAMPLE 11

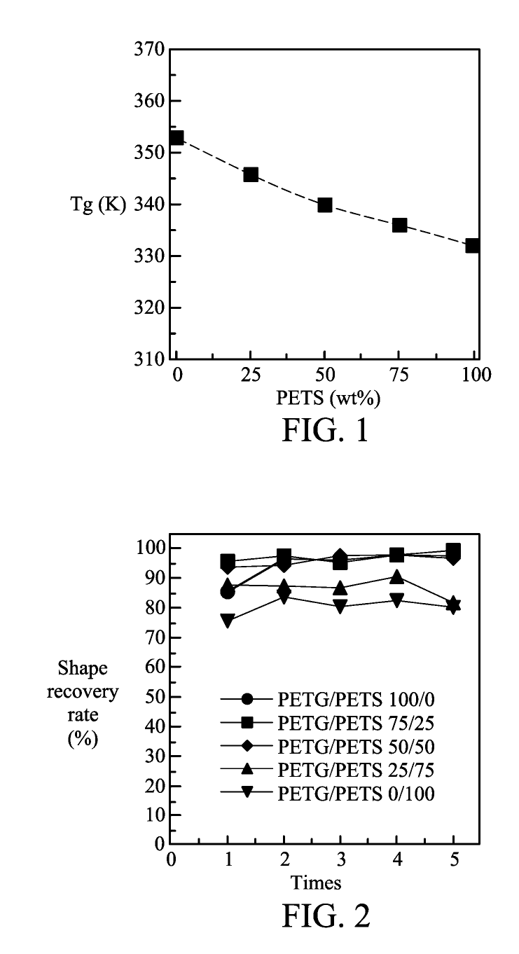

FIG. 1 shows the glass transition temperature (measured by Differential Scanning Calorimeter (DSC)) of shape memory materials respectively disclosed in Examples 1-5.

As shown in FIG. 1, the relationship between the glass transition temperature and the weight ratio of PETG/PETS can be represented by a linear trend. After further analysis, the glass transition temperature of the blend (Tg) was shown to relate to the glass transition temperature of the amorphous polyester (Tg₁) and the glass transition temperature of the semi-crystalline polyester (Tg₂), according to the relationship equation:

$$\frac{1}{{T}_{g}} = \frac{{w}_{1}}{{T}_{g 1}} + \frac{{w}_{2}}{{T}_{g 2}} .$$

Particularly, W₁ and W₂ respectively represented the weight ratio of the amorphous polyester and the semi-crystalline polyester. In general, the shape memory materials have a shape memory start-up temperature which is 15° C. higher than the glass transition temperature thereof.

Measurement of Shape Recovery Rate

### EXAMPLE 12

FIG. 2 shows the shape recovery rate of the shape memory materials respectively disclosed in Examples 1-5.

The method for measuring shape recovery rate was as follows.

First, after drying by a vacuum oven for 12 hrs, the shape memory material was melt rolled by thermal compression, and thus shape memory material slices with a thickness of 1 mm were obtained. After quenching by a water bath, the shape memory material slices were cut into strips (serving as test specimens).

Next, both ends of the test specimen were fixed by a tensile machine, and the test specimen had a length ro.

Next, the test specimen was heated to a shape memory start-up temperature (15° C. higher than the glass transition temperature thereof) for 15 mins.

Next, the test specimen was stretched to twice the original length by the tensile machine, and the stretched test specimen had a stretched length rᵢ.

Next, the environmental temperature was reduced to 10° C. lower than the glass transition temperature of the shape memory material for a period of time.

Next, one end of the test specimen was released from the tensile machine and the environmental temperature was increased to 10° C. greater than the glass transition temperature of the shape memory material for a period of time.

Finally, the test specimen was removed from the tensile machine and the length thereof was measured and defined as r_{f}. The shape recovery rate can be calculated via the relationship equation as below:

$$shape * recovery * rate = ( \frac{{r}_{f} - {r}_{i}}{{r}_{f} - {r}_{o}} ) \times 100 \% .$$

As shown in FIG. 2, the shape memory materials of the invention, prepared from melt blending an amorphous polyester and a semi-crystalline polyester, had superior shape recovery rate.

Accordingly, the method for fabricating shape memory materials of the invention can reduce costs and process complexity in comparison with the conventional method of chemical synthesis. Further, in comparison with the shape memory material prepared by conventional blending of polymers, the method of the invention substitutes amorphous and semi-crystalline polyesters for conventional specific polymers, thereby reducing the cost. Further, the shape memory start-up temperature of the shape memory materials of the invention can be modified by altering the amorphous polyesters/semi-crystalline polyesters weight ratio and the shape recovery rate of shape memory materials of the invention can be increased to more than 90%.

While the invention has been described by way of example and in terms of embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A shape memory material, comprising:
a blend prepared by melt blending an amorphous polyester and a semi-crystalline polyester.

2. The shape memory material as claimed in claim 1, wherein the weight ratio between the amorphous polyester and the semi-crystalline polyester is between 9:1 and 1:9.

3. The shape memory material as claimed in claim 1, wherein the glass transition temperature of the shape memory material is modified by the weight ratio between the amorphous polyester and the semi-crystalline polyester.

4. The shape memory material as claimed in claim 1, wherein the shape recovery rate of the shape memory material is modified by the weight ratio between the amorphous polyester and the semi-crystalline polyester.

5. The shape memory material as claimed in claim 1, wherein the start-up of shape memory ability of the shape memory material is achieved by heating the shape memory material over the glass transition temperature thereof.

6. The shape memory material as claimed in claim 1, wherein the amorphous polyester which exhibits a physical property of non-crystallization comprises poly(ethylene-co-cyclohexane dimethanol terephthalate) (PETG).

7. The shape memory material as claimed in claim 1, wherein the semi-crystalline polyester which exhibits a physical property of crystallization comprises poly(ethylene terephthalate) (PET), poly(ethylene terephthalate-co-ethylene succinate) (PETS), poly(butylene terephthalate) (PBT).

8. A method for fabricating shape memory material, comprising:
melt blending an amorphous polyester and a semi-crystalline polyester.

9. The method as claimed in claim 8, wherein the weight ratio between the amorphous polyester and the semi-crystalline polyester is between 9:1 and 1:9.

10. The method as claimed in claim 8, wherein the glass transition temperature of the shape memory material is modified by the weight ratio between the amorphous polyester and the semi-crystalline polyester.

11. The method as claimed in claim 8, wherein the shape recovery rate of the shape memory material is modified by the weight ratio between the amorphous polyester and the semi-crystalline polyester.

12. The method as claimed in claim 8, wherein the start-up of shape memory ability of the shape memory material is achieved by heating the shape memory material over the glass transition temperature thereof.

13. The method as claimed in claim 8, wherein the amorphous polyester which exhibits a physical property of non-crystallization comprises poly(ethylene-co-cyclohexane dimethanol terephthalate) (PETG).

14. The method as claimed in claim 8, wherein the semi-crystalline polyester which exhibits a physical property of crystallization comprises poly(ethylene terephthalate)(PET), poly(ethylene terephthalate-co-ethylene succinate)(PETS), poly(butylene terephthalate)(PBT).
